(19) United States
(12) Patent Application Publication
(10) Pub. No.: US 2012/0158599 A1
(43) Pub. Date: Jun. 21, 2012

(54) SYSTEM AND METHOD FOR ANALYZING OFFICE ACTION OF PATENT APPLICATION

(75) Inventors: CHUNG-I LEE, Tu-Cheng (TW); HAI-HONG LIN, Shenzhen City (CN); DE-YI XIE, Shenzhen City (CN); SHUAI-JUN TAO, Shenzhen City (CN); ZHI-QIANG YI, Shenzhen City (CN); AN-SHENG LUO, Shenzhen City (CN); WEI JIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/280,358

(22) Filed: Oct. 25, 2011

(30) Foreign Application Priority Data
Dec. 20, 2010 (CN) 201010596747.X

(51) Int. Cl. G06Q 50/18

(52) U.S. Cl. 705/310

(57) ABSTRACT

In a method for analyzing an office action of a patent application using a computing device, an office action of a patent application that is downloaded from a patent office website is parsed using predetermined regular expressions (RE). The patent information of patent application is extracted from the office action according to predetermined keywords of the patent information if the office action fails to be parsed by the regular expressions. A regular expression of the extracted patent information is generated according to determined rules, and is stored into the storage system, to parse another office action using the generated regular expression.

### BACKGROUND

1. Technical Field

Embodiments of the present disclosure relate generally to document analysis technologies, and particularly to a system and method for analyzing office actions of patent applications.

2. Description of Related Art

Patent offices, such as the United States Patent and Trademark Office (USPTO), European Patent Office (EPO), State Intellectual Property Office of People's Republic of China (SIPO), and Japanese Patent Office (JPO), may send one or more office actions during the examination process of a patent application. The office action is a document written by a patent examiner, using a template, in response to review of the patent application by an examiner. When a patent applicant receives an office action, the office action must be processed to obtain patent information, such as an application number, filing date, fee payment. The office action may be manually processed, or automatically processed using software programs. However, the software programs may occur some unexpected errors when the template of the office action is changed. Therefore, a more efficient system and method for analyzing office actions of patent applications is desired.

### BRIEF DESCRIPTION OF THE DRAWINGS

FIG. 1 is a schematic diagram illustrating one embodiment of a computing device including an analysis system.

FIG. 2 is a detailed block diagram of one embodiment of the analysis system of the computing device of FIG. 1.

FIG. 3 is a flowchart of one embodiment of a method for analyzing an office action of a patent application using the analysis system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

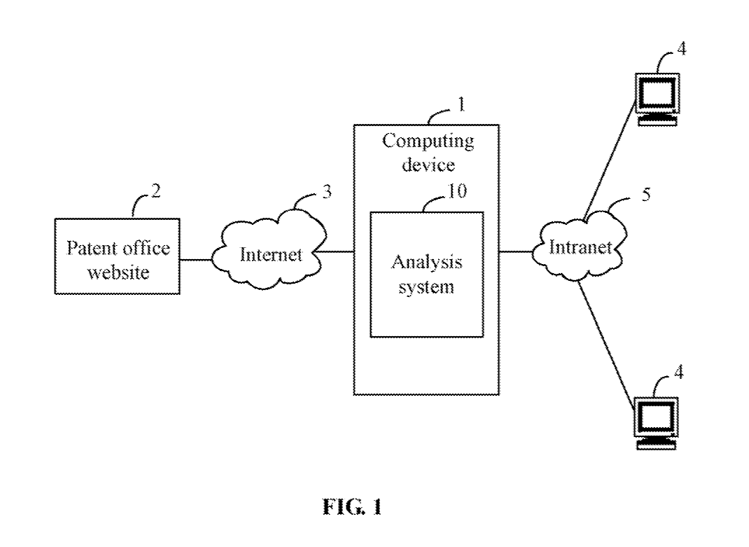

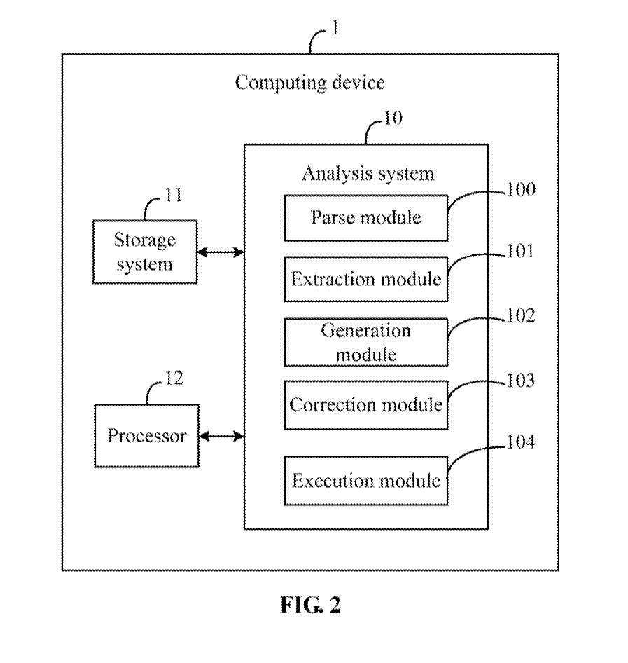

FIG. 1 is a schematic diagram illustrating one embodiment of a computing device 1 including an analysis system 10. The analysis system 10 is operable to analyze office actions of patent applications, and includes a plurality of functional modules (see in FIG. 2). In one embodiment, the office action is a document written by a patent examiner in response to a received patent application, and is sent from a patent office, such as United States Patent and Trademark Office (USPTO), European Patent Office (EPO), State Intellectual Property Office of People's Republic of China (SIPO), and Japanese Patent Office (JPO). The computing device 1 may be a computer, or a server, for example. The computing device 1 communicates with one or more patent office websites 2 through the Internet 3, and communicates with a plurality of client computers 4 through an intranet 5. The patent office websites 2 are maintained by the patent offices. It is understood that FIG. 1 is only one example of the computing device 1 that can include more or fewer components than those shown in the embodiment, or a different configuration of the various components.

FIG. 2 is a detailed block diagram of one embodiment of the analysis system 10 of the computing device 1 of FIG. 1. In one embodiment, the analysis system 10 may include a plurality of software programs in the form of one or more computerized instructions stored in a storage system 11 of the computing device 1, and executed by a processor 12 of the computing device 1, to perform operations of the computing device 1. In the embodiment, the analysis system 10 includes a parse module 100, an extraction module 101, a generation module 102, a correction module 103, and an execution module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The parse module 100 parses an office action using predetermined regular expressions (RE) stored in the storage system 11, to obtain patent information of a patent application of the office action, when the office action is downloaded from the patent office website 2. In the embodiment, the regular expressions provide a concise and flexible means for matching strings of text of the office action, such as particular characters, words, or patterns of characters. A regular expression is written in a formal language that can be interpreted by a regular expression processor, a program that either serves as a parser generator or examines text and identifies parts that match the provided specification. The patent information include, but is not limited to, an application number, a filing date, a publish number, a publish date, a patent number, and fee payment of the patent application, for example.

In one embodiment, the parse module 100 may parse the office action by the following steps. First, the parse module 100 converts the office action into a predefined format document, such as a JPG document, or a TIF document. Second, the parse module 100 extracts characters from the converted document using a character recognition method, such as an optical character recognition (OCR) method. Third, the parse module 100 obtains the patent information from the extracted characters using the regular expressions. In the embodiment, the characters may be composed of numbers, letters, and others special characters of the office action.

The parse module 100 determines whether the office action is parsed successfully using the regular expressions. In one embodiment, if the desired patent information, such as the application number of the patent number, is obtained from the office action using the regular expressions, the parse module 100 determines the office action is successfully parsed. If the desired patent information is not obtained, the parse module 100 determines the office action fails to be parsed. The obtained patent information may be sent to the client computer 4 through the intranet 5.

The extracted module 101 extracts the patent information of the patent application from the office action according to predetermined keywords of the patent information. In one example, the extracted module 101 may search the extracted characters using keywords “APPLICATION NO.” of the application number of the patent application, and extracts numbers after the keywords “APPLICATION NO.” as the application number.

The generation module 102 generates a regular expression of the extracted patent information according to determined rules. In one embodiment, the determined rules include, but are not limited to, each number of the extracted patent information is replaced by “\d”, each space character of the extracted patent information is replaced by “\s”, and characters “a, b, . . . , z” and “A, B, . . . , Z” are replaced by “[A-Za-z]”. For example, if the extracted patent information is the application number “12/547,517”, the generated regular expression is “\d\d/\d\d\d,\d\d\d”, which may be also described as “\d{2}/\d{3},\d{3}”.

The correction module 103 sends the generated regular expression to the client computer 4 to confirm whether the generated regular expression is correct. In one embodiment, the generated regular expression may be displayed on a display screen of the client computer 4, and confirmed by a user of the client computer when the regular expression is displayed. If the generated regular expression is not correct, the generated regular expression is corrected by the user using the client computer 4. And the corrected regular expression is obtained by the correction module 103 from the client computer 4.

The execution module 104 stores the generated regular expression or the corrected regular expression into the storage system 11, so that the patent information of other office actions can be obtained using the generated/corrected regular expression.

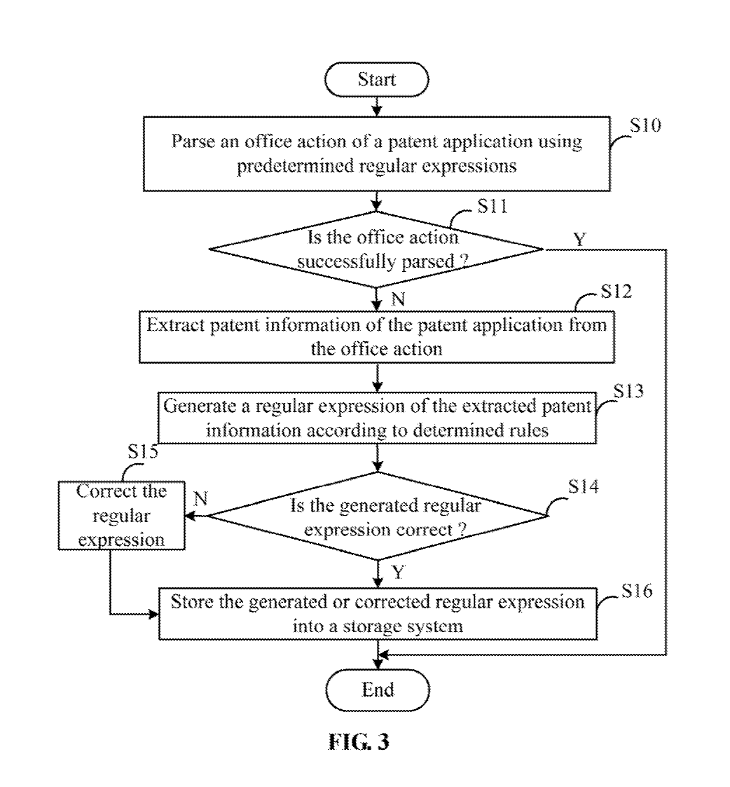

FIG. 3 is a flowchart of one embodiment of a method for analyzing an office action of a patent application using the analysis system 10 of FIG. 1. Depending on the embodiment, additional blocks may be added, others removed, and the ordering of the blocks may be changed.

In block S10, the parse module 100 parses an office action of a patent application using predetermined regular expressions (RE) stored in the storage system 11, when the office action is downloaded from the patent office website 2. The patent information includes, but is not limited to an application number, a filing date, a publish number, a publish date, a patent number, and fee payment of the patent application, for example.

In block S11, the parse module 100 determines whether the office action is parsed successfully using the regular expressions. If the office action is successfully parsed, the procedure ends. If the office action fails to be parsed, block S12 is implemented. In one embodiment, if the desired patent information, such as the application number of the patent number, is obtained from the office action using the regular expressions, the parse module 100 determines the office action is successfully parsed. If the desired patent information is not obtained, the parse module 100 determines the office action fails to be parsed.

In block S12, the extracted module 101 extracts patent information of the patent application from the office action according to predetermined keywords of the patent information. In one example, the extracted module 101 may search the extracted characters using keywords “APPLICATION NO.” of the application number of the patent application, and extracts numbers after the keywords “APPLICATION NO.” as the application number.

In block S13, the generation module 102 generates a regular expression of the extracted patent information according to determined rules. In one embodiment, the determined includes, but not limited to, each number of the extracted patent information is replaced by “\d”, each space character of the extracted patent information is replaced by “\s”, and characters “a, b, . . . , z” and “A, B, . . . , Z” are replaced by “[A-Za-z]”.

In block S14, the correction module 103 sends the generated regular expression to the client computer 4 to confirm whether the generated regular expression is correct. If the generated regular expression is not correct, block S15 is implemented. If the generated regular expression is correct, block S16 is implemented.

In block S15, the generated regular expression is corrected by the user using the client computer 4, and the corrected regular expression is obtained by the correction module 103.

In block S16, the execution module 104 stores the generated regular expression or the corrected regular expression into the storage system 11, so the patent information of other office actions can be obtained using the generated/corrected regular expression.

All of the processes described above may be embodied in, and fully automated via, functional code modules executed by one or more general purpose computing devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for analyzing a office action of a patent application using a computing device, the patent application downloaded from a patent office website, the method comprising:
parsing the office action of the patent application using predetermined regular expressions that are stored in a storage system of the computing device;
determining whether the office action is parsed successfully by the regular expressions;
extracting patent information of the patent application from the office action according to predetermined keywords of the patent information;
generating a regular expression of the extracted patent information according to determined rules;
sending the generated regular expression to a client computer that in communication with the computing device to confirm whether the generated regular expression is correct;
storing the generated regular expression into the storage system if the generated regular expression is correct, to parse another office action using the generated regular expression stored in the storage system; or
correcting the generated regular expression using the client computer, and storing the corrected regular expression into the storage system, if the generated regular expression is not correct.

2. The method according to claim 1, wherein parsing step comprises:
converting the office action into a predefined format document;
extracting characters from the converted document using a character recognition method; and
obtaining the patent information from the extracted characters using the regular expressions.

3. The method according to claim 1, wherein the determined rules comprise that:
each number of the extracted patent information is replaced by “\d”;
each space character of the extracted patent information is replaced by “\s”; and
characters “a, b, . . . , z” and “A, B, . . . , Z” are replaced by “[A-Za-z]”.

4. The method according to claim 1, wherein the patent information comprise an application number, a filing date, a publish number, a publish date, a patent number, and fee payment of the patent application.

5. A computing device, comprising:
a storage system;
at least one processor;
one or more programs stored in the storage system and being executable by the at least one processor, the one or more programs comprising:
a parse module operable to parse an office action of a patent application that is downloaded from a patent office website using predetermined regular expressions (RE) that are stored in the storage system, and determine whether the office action is parsed successfully by the regular expressions;
an extracting module operable to extract patent information of the patent application from the office action according to predetermined keywords of the patent information;
a generation module operable to generate a regular expression of the extracted patent information according to determined rules;
a correction module operable to send the generated regular expression to a client computer that in communication with the computing device to confirm whether the generated regular expression is correct, and correct the generated regular expression using the client computer; and
an execution module operable to store the generated regular expression into the storage system if the generated regular expression is correct, or store the corrected regular expression into the storage system, to parse another office action using the generated/corrected regular expression.

6. The computing device according to claim 5, wherein office action is parsed by:
converting the office action into a predefined format document;
extracting characters from the converted document using a character recognition method; and
obtaining the patent information from the extracted characters using the regular expressions.

7. The computing device according to claim 5, wherein the determined rules comprise that:
each number of the extracted patent information is replaced by “\d”;
each space character of the extracted patent information is replaced by “\s”; and
characters “a, b, . . . , z” and “A, B, . . . , Z” are replaced by “[A-Za-z]”.

8. The computing device according to claim 5, wherein the patent information comprise an application number, a filing date, a publish number, a publish date, a patent number, and fee payment of the patent application.

9. A non-transitory storage medium storing a set of instructions, the set of instructions capable of being executed by a processor of a computing device, cause the computing device to perform a method for analyzing an office action of a patent application, the patent application downloaded from a patent office website, the method comprising:
parsing the office action using predetermined regular expressions (RE) that are stored in a storage system of the computing device;
determining whether the office action is parsed successfully by the regular expressions;
extracting patent information of the patent application from the office action according to predetermined keywords of the patent information;
generating a regular expression of the extracted patent information according to determined rules;
sending the generated regular expression to a client computer that in communication with the computing device to confirm whether the generated regular expression is correct;
storing the generated regular expression into the storage system if the generated regular expression is correct, to parse another office action using the generated regular expression stored in the storage system; or
correcting the generated regular expression using the client computer, and storing the corrected regular expression into the storage system, if the generated regular expression is not correct.

10. The non-transitory storage medium according to claim 9, wherein parsing step comprises:
converting the office action into a predefined format document;
extracting characters from the converted document using a character recognition method; and
obtaining the patent information from the extracted characters using the regular expressions.

11. The non-transitory storage medium according to claim 9, wherein the determined rules comprise that:
each number of the extracted patent information is replaced by “\d”;
each space character of the extracted patent information is replaced by “\s”; and
characters “a, b, . . . , z” and “A, B, . . . , Z” are replaced by “[A-Za-z]”.

12. The non-transitory storage medium according to claim 9, wherein the patent information comprise an application number, a filing date, a publish number, a publish date, a patent number, and fee payment of the patent application.

13. The non-transitory storage medium according to claim 9, wherein the medium is selected from the group consisting of a hard disk drive, a compact disc, a digital video disc, and a tape drive.
